(19) United States
(12) Patent Application Publication
(10) Pub. No.: US 2021/0142419 A1
(43) Pub. Date: May 13, 2021

(54) SYSTEMS AND METHODS FOR MANAGING USER ACCOUNTS ACCORDING TO ELECTRONIC DEVICE USAGE EVENTS

(71) Applicant: STATE FARM MUTUAL AUTOMOBILE INSURANCE COMPANY, Bloomington, IL (US)

(72) Inventors: Timothy Joel Davis, Warrenville, IL (US); Scott T. Christensen, Salem, OR (US)

(21) Appl. No.: 14/973,278

(22) Filed: Dec. 17, 2015

Related U.S. Application Data
(60) Provisional application No. 62/100,327, filed on Jan. 6, 2015.

(51) Int. Cl. G06Q 40/08; H04W 24/08; H04W 4/04; G06Q 30/02

(52) U.S. Cl. CPC G06Q 40/08; G06Q 30/0207; H04W 4/046; H04W 24/08

(57) ABSTRACT

Methods and systems for managing user accounts based upon the detection of various usage events associated with mobile or other electronic devices are provided. An electronic device may be located within a vehicle. During operation of the vehicle, the electronic device is configured to detect and record various usage events. Based upon the usage events or absence of usage events, either the electronic device or a remote server may determine how one or more user accounts are affected or impacted. The usage events may be related to type of smart phone usage, such as texting, web-surfing, telephone calls, etc., and/or simultaneous vehicle usage (e.g., vehicle movement or rest). The remote server may process the one or more user accounts accordingly and notify the electronic device of the processing. The electronic device may present any detected usage events or account changes via a user interface.

### CROSS-REFERENCE TO RELATED APPLICATIONS

This application claims benefit of the filing date of U.S. Provisional Patent Application No. 62/100,327 (filed Jan. 6, 2015, and entitled “SYSTEMS AND METHODS FOR MANAGING VEHICLE INSURANCE POLICIES ACCORDING TO ELECTRONIC DEVICE USAGE EVENTS”);—which is hereby incorporated by reference in its entirety.

### FIELD OF THE DISCLOSURE

The present disclosure generally relates to vehicle operation. More particularly, the present disclosure may relate to systems and methods for detecting distracted driving instances or events and determining effects thereof, as well as discouraging certain distracted driving behaviors.

### BACKGROUND

Distracted driving is a major risk to drivers, pedestrians, and property. Distractions vary in the level in which they impair a driver's ability to adequately concentrate on the task at hand, particularly distractions involving multiple physical and cognitive actions in an overlapping manner. For example, mobile device or smartphone usage, whether making phone calls, sending text messages, and/or browsing the Internet, may lead to an increased occurrence of vehicular accidents.

Not only does distracted driving lead to vehicular accidents, but it may also lead to increased economic costs. In particular, the cost of insuring vehicle operators may be increased as a result of distracted driving-related incidents. Insurance providers do not have representative ratings inputs to use in evaluating and pricing this increased risk, which may result in mismatches between premium and risk, and ultimately in greater exposure for the company and higher prices for drivers, notably those who do not use cell phones while driving. Accordingly, there is an opportunity to effectively and accurately price vehicular insurance policies based upon certain distracted driving conditions.

### SUMMARY

The present embodiments may relate to, inter alia, systems and methods for monitoring electronic or mobile device usage by an individual within a vehicle and performing various functionalities corresponding to the usage. The individual may have an account that may be associated with a certain vehicle. In particular, the account may be in the form of a vehicle insurance policy that is issued by an insurance provider or may be a general account that accumulates points or other incentives. In one implementation, a remote server may manage the account based upon any detected electronic device usage. Generally, certain electronic device usage by a driver (or in some cases, a passenger) may be considered an unsafe or risky behavior which the insurance provider may deem to negatively impact the account. Of course, certain electronic device events may be considered “good” behaviors, such as a locking of the electronic device. Accordingly, different electronic device usage events may correspond to different impacts or effects on the account.

In one aspect, a method implemented by, or executed in, an electronic device of managing an account of a user associated with a vehicle based upon usage associated with the electronic device may be provided. The method may include (1) detecting at least one usage event associated with the electronic device; (2) detecting sensor data in response to detecting the at least one usage event; and/or (3) determining, by one or more processors based upon the sensor data, that the electronic device is being transported by the vehicle. The method may further include (4) determining, by the one or more processors based upon the at least one usage event, an effect to the account of the user; and/or (5) communicating, to a remote server via a communication module, an indication of the effect to the account of the user, wherein the remote server processes the account of the user according to the effect. According to embodiments, the effect may be in the form of one or more incentives such as, for example, a discount to an insurance premium, various non-monetary credits or points, monetary amounts, social networking game points or badges, and/or others. The method may include additional, fewer, or alternate actions, including those discussed elsewhere herein.

In another aspect, a method implemented by, or executed in, an electronic device of rewarding, based upon usage associated with the electronic device, an individual having an account associated with a vehicle may be provided. The method may include (1) detecting an initiation of a trip by the vehicle; (2) monitoring, by one or more processors, usage of the electronic device by the individual during the trip; and/or (3) detecting a conclusion of the trip. The method may further include, responsive to detecting the conclusion of the trip, (4) analyzing, by the one or more processors, the usage of the electronic device by the individual during the trip, (5) based upon the analyzing, determining that the individual did not interact with the electronic device during the trip, (6) determining, by the one or more processors, an effect to the account of the individual, and/or (7) communicating, to a remote server via a communication module, an indication of the effect to the account of the individual, wherein the remote server processes the account of the individual according to the effect. The method may include additional, fewer, or alternate actions, including those discussed elsewhere herein.

In a further aspect, a system for managing an account of a user based upon usage associated with an electronic device may be provided. The system may include (1) a communication module configured to communicate data; (2) a memory adapted to store non-transitory computer executable instructions; and/or (3) a particularly programmed processor adapted to interface with the communication module. The processor may be configured to execute the non-transitory computer executable instructions to cause the processor to: (A) receive, from an electronic device via the communication module, an indication of at least one usage event associated with the electronic device, (B) determine, based upon a location or movement metric of the electronic device, that the electronic device is being transported by a vehicle, (C) determine, based upon the at least one usage event, an effect to the account of the user, and/or (D) process the account of the user according to the effect. The system may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary environment including components and entities associated with detecting electronic device usage events and facilitating insurance policy processing, in accordance with some embodiments;

FIG. 2 depicts an exemplary signal diagram associated with detecting electronic device usage events and facilitating insurance policy processing, in accordance with some embodiments;

FIGS. 3A and 3B depict exemplary interfaces associated with presenting insurance processing effects corresponding to detected electronic device usage events, in accordance with some embodiments;

FIGS. 4A and 4B depict exemplary interfaces associated with presenting certain information and data corresponding to detected electronic device usage events, in accordance with some embodiments;

FIG. 5 depicts an exemplary flow diagram associated with detecting electronic device usage instances and facilitating insurance policy processing, in accordance with some embodiments;

FIG. 6 depicts an additional exemplary flow diagram associated with detecting electronic device usage instances and facilitating insurance policy processing, in accordance with some embodiments;

FIG. 7 is a block diagram of an exemplary electronic device in accordance with some embodiments; and

FIG. 8 is a block diagram of an exemplary processing server in accordance with some embodiments.

### DETAILED DESCRIPTION

According to embodiments, methods and systems for detecting cell phone usage while driving and differentiating types of usage in order to discount rates for non-users are described. The methods and system may involve utilizing a pre-existing telematics platform (e.g., Drive Safe & Save from State Farm®) or a new, native application on a mobile device to capture and send additional information. The additional information may pertain to cell phone usage events, frequency, duration, and type (e.g., viewed texts, typed texts, web browsing, incoming call, outgoing call). Movement of the vehicle may be captured and correlated through a short range communication (e.g., a Bluetooth® connection) to the telematics device or a native application utilizing typical location services (e.g., switching cell towers in under 5 minutes would imply rapid travel rather than walking). An additional dimension, namely, whether the device was connected to an active hands-free device, may also be considered.

Various techniques may be used to break down types and frequencies of usage (with discounts or incentives inversely related to usage events that are in the “bad” usage category). For example, no usage may result in the best discount or incentive, as hands-free usage has not been shown to result in a lower cognitive load than regular device usage while driving. In this model, GPS/Mapping applications may not “count” as usage. For further example, hands-free may result in some discount or incentive, whereby this usage may be detected based upon Bluetooth headset activation and linkage. Further, for example, non-hands-free usage may result in no discount or incentive at a certain threshold of usage events. Of course, some drivers may consider texting while stopped at a light or in traffic to not be a problem, but this usage is still a risk (and may be illegal in some jurisdictions).

Discounts may also be used as a sole incentive, meaning that all leveling above would be modified to start with no discount for no change in typical device phone usage patterns, but with discounts starting at the “hands-free” or “no usage” levels. This implementation may be further enhanced by correlating the primary driver of a given vehicle to the owner/user of a given device. In this way, a higher level of accuracy about driver/device user correlation may be achieved (and thus, appropriate discounts provided) because of the high likelihood that a primary driver of a vehicle is the actual driver on any given occasion, and the high likelihood that a device user is the device owner on any given occasion. However, given the distraction that may be caused by passenger cell phone usage, in some implementations it may not be critical to overly distinguish between passenger and driver usage of a driver's device.

Should it be considered problematic to gather technically differentiated information about distracting electronic device usage events (e.g., texting while in motion), the data gathering may be generalized to capture all device usage that occurs while the correlated vehicle is in motion. Because the different usage types are generally about as distracting relative to each other, it might not make a significant difference to rating inputs whether a driver is calling hands-free, non-hands-free, reading texts, writing texts, browsing the web, etc.

A further enhancement may involve an active metering component, in which a user of an application may have active feedback about the premium savings accumulating over time. For example, avoiding cell phone usage for a given trip may save a customer $0.50 on their premium. The application may provide per-trip feedback, as well as periodic tracking of “performance” and accumulated savings resulting from avoiding device usage. This may serve as a reminder of the efficacy of the changed driving behavior, rather than only at the time of payment of insurance premiums. In some implementations, the application may present a simple red/green distinction between whether the device usage of the driver positively or negatively affected a premium for a given period, or how driving behavior is affecting a user's premiums versus other typical customers.

As this idea may be appealing to parents of youthful drivers—both as a safety device and a cost-saving device—a “parent” version of the application may be developed that may interface to multiple youthful drivers' performance over time, reporting on accumulated premium savings (or additional cost) and a “cell phone sobriety” period through time.

The systems and methods may be further enhanced by inserting a component of “challenge” to the user. For example, 3000 consecutive minutes of phone-free driving may result in $30 of premium savings, but any interruption in the consecutive string of phone-free driving minutes may send the counter back to zero. Forced closure of the application may also reset the counter. For further example, a user may accumulate 100 consecutive hours of phone-free driving and may have this total adjusted based on certain detected usage events. Continuing with the example, placing a phone call may result in ten (10) hours being subtracted from the accumulated total and sending a text message may reset the accumulated total to zero. Of course, the electronic device may determine and modify any user accounts accordingly (e.g., by awarding points based on the accumulated total).

The challenge or game aspect of the systems and methods may be further enhanced by enabling customers to know how they rank against other, similar drivers. For example, a customer may be informed (e.g., in dollar and cent figures) that their positive driving behaviors are having a greater or lesser impact on their premiums than other participants (or non-participants). This may not be an actual comparison of premiums, but rather, a comparison of how successful participation in the program is changing that customer's “rank” versus other drivers (in terms of safety and money saved). If the “average” driver saves $10 a year by using their mobile device only 10% of the time they are driving, a “super” driver may save $100 a year by using their mobile device none of the time. That latter driver may be provided with performance feedback about that metric—namely, that they are saving $90 more than the “average” participant as a direct result of their better driving. A similar comparison may be made between the year's driving behavior discount and previous years' (for the same driver—a “personal best” challenge). This performance feedback may not need to be limited to the impact of cell phone usage, but may extend to other areas of driving behavior (e.g., mileage, hard braking or turns, speed, driving with damaged vehicle systems, etc.).

### I. EXEMPLARY EMBODIMENTS

The systems and methods may be facilitated by various hardware and software components. In some implementations, the electronic device may monitor its own usage events or may interface with a peripheral component configured to monitor various device usage and/or vehicle driving data. The usage events may be any type of interaction or usage, either manually initiated/performed by a user or automatically initiated/performed by the electronic device. For example, a usage event may be an access of the electronic device or application thereof, a communication initiated by the electronic device, a communication destined for the electronic device, an unlocking event of the electronic device, any connection to a peripheral device or component by the electronic device, and/or other events or interactions.

The electronic device may be configured to monitor for any type of usage event, either directly or via interfacing with a peripheral component, as well as determine whether the electronic device is located within a vehicle and/or whether the vehicle is in motion or otherwise engaged in a “trip.” The electronic device may perform the vehicle trip determination using any combination of location data, speed/velocity data, and/or connection data, and/or from data received from an on-board device in the vehicle. The electronic device may also gather various sensor data, registration data, or the like, to determine whether the usage event may be attributed to the driver of the vehicle or a passenger of the vehicle.

According to some embodiments, each usage event, or combination of usage events, may have an associated effect on an account of a user (e.g., an operator or a passenger of the vehicle). In embodiments, the account of the user may be a vehicle insurance policy, or may be another type of account held by the user. The effect may be based upon circumstances of the vehicle (e.g., velocity, location, driver vs. passenger, etc.). For example, the electronic device may account for a usage event when a velocity of the vehicle exceeds a certain amount (e.g., 80 mph), when the vehicle is being operated at a certain time of day (e.g., between 12:00 AM and 4:00 AM), or when the vehicle is being operated in a certain location (e.g., in a school zone). The usage events may be treated singularly or in combination with other usage events, and may be monitored or compiled in real-time, or in response to certain triggers, such as the conclusion of time periods (e.g., daily, weekly, monthly, etc.), the conclusion of a vehicle trip, in response to a user selection, and/or the like. Of course, a determined effect may be based upon the lack of any detected usage events. For example, if the electronic device does not detect any usage events during the last ten (10) vehicle trips, then the associated effect may be a $5.00 policy premium discount.

The electronic device may determine one or more effects to the account of the individual/user based upon any detected usage events or combinations of usage events, and communicate the determined effect(s) to a remote server (e.g., an insurance provider). In some implementations, the electronic device may communicate the detected usage events to the remote server, which may determine the one or more effects to the account based upon the received information. The remote server may process/modify the account according to any determined effects, and/or communicate confirmation of the processing/modification to the electronic device. In this regard, the electronic device may present or indicate the effect of certain usage events on the individual's account so that the individual may effectively gauge the results of certain of his/her actions.

The systems and methods therefore may offer numerous benefits. In particular, entities such as insurance providers may be able to receive accurate and relevant device usage information associated with vehicle operation. In this regard, the insurance providers may use this data as representative ratings inputs to evaluate and price vehicle insurance policies. The systems and methods may also benefit customers such as policyholders, as vehicle operators who generally do not interact with electronic devices while driving may be afforded with insurance policies more accurately priced to reflect this behavior. Additionally, the systems and methods may support the communication of feedback to vehicle operators that encourages the vehicle operators to modify certain behaviors related to device usage. A general improvement in device usage may generally result in fewer driving-related incidents, as well as reduced insurance costs. It should be appreciated that further benefits to the systems and methods may be envisioned.

### II. EXEMPLARY ENVIRONMENT AND COMPONENTS FOR DETECTING ELECTRONIC DEVICE USAGE EVENTS AND FACILICATING ACCOUNT PROCESSING

FIG. 1 depicts an exemplary environment 100 associated with detecting electronic device usage events and facilitating insurance processing related thereto. Although FIG. 1 depicts certain entities, components, and devices, it should be appreciated that fewer, additional, or alternate entities and components are envisioned.

As illustrated in FIG. 1, the environment 100 includes a vehicle 105 that may be any type of car, automobile, truck, motorcycle, fleet of vehicles, marine vessel, plane, or other vehicle capable of being driven or operated by a driver or operator. The vehicle 105 may have one or more electronic devices 110, 107 associated therewith. In particular, the electronic device 107 may be installed as an on-board dash of the vehicle 105, such as part of an original equipment manufacturer (OEM) installation on the vehicle 105. Further, the electronic device 110 may belong to an individual associated with the vehicle 105, such as an operator or a passenger. For example, the electronic device 106 may be a mobile device (e.g., smartphone) of the vehicle operator. It should be appreciated that other types of electronic devices and/or mobile devices are envisioned, such as notebook computers, tablets, phablets, GPS (Global Positioning System) or GPS-enabled devices, smart watches, smart glasses, smart bracelets, wearable electronics, PDAs (personal digital assistants), pagers, computing devices configured for wireless communication, and/or the like. Although only a single vehicle 105 is depicted in FIG. 1, it should be appreciated that multiple vehicles having associated electronic devices are envisioned.

Although not illustrated in FIG. 1, the vehicle 105 may also be equipped with a set of sensors that may be configured to record various telematics data associated with the vehicle 105. According to some implementations, the set of sensors may include any type of sensor configured to detect vehicle movement or general operation including, for example, a braking sensor, a speedometer, a tachometer, a throttle position sensor, an accelerometer, an optical sensor, a microphone, a gyroscope, a location module (e.g., GPS sensor), and/or others.

The set of sensors may be generally configured to measure vehicle operation data. In some specific instances, the set of sensors may also be used to monitor vehicle lane deviation, vehicle swerving, vehicle lane centering, vehicle acceleration along a single axis or multiple axes, and/or vehicle distance to other objects. It should be appreciated that these types of sensors and measurable metrics are merely examples and that other types of sensors and measureable metrics are envisioned. Each of the electronic devices 107, 110 may be configured to interface with the set of sensors and retrieve any recorded vehicle operation data.

The electronic devices 107, 110 may each be configured to communicate with a remote entity 115 via a network 120. The network 120 may facilitate any type of data communication via any standard or technology (e.g., GSM, CDMA, TDMA, WCDMA, LTE, EDGE, OFDM, GPRS, EV-DO, UWB, IEEE 802 including Ethernet, WiMAX, Wi-Fi, and/or others). The remote entity 115 may be any individual, group of individuals, company, corporation, or other type of entity that may manage one or more accounts of users or individuals (e.g., passengers or operators of the vehicle 105). For example, the remote entity 115 may be an insurance provider that may offer and/or issue insurance policies for customers, such as a vehicle insurance policy for the vehicle 105 and/or for an operator thereof. According to some embodiments, the remote entity 115 may include one or more processing server(s) 130 configured to facilitate various of the functionalities as discussed herein.

Although FIG. 1 depicts the processing server 130 as a part of the remote entity 115, it should be appreciated that the processing server 130 may be separate from (and connected to or accessible by) the remote entity 115. Further, although some embodiments are described as being facilitated by an insurance provider, it should be appreciated that other central entities (such as any company, corporation, individual, group of individuals, etc.) may implement the embodiments and functionalities. Accordingly, it is not necessary for the vehicle 105 to have an associated vehicle insurance policy for the vehicle owner to enjoy the benefits of the systems and methods.

An individual or user associated with the vehicle 105 (e.g., an owner or operator of the vehicle 105) may have an account associated with operation of the vehicle 105. For example, the individual be a policyholder for a vehicle insurance policy issued by an insurance provider. For further example, the account may maintain certain incentives, awards, points, or the like that the individual may accumulate. According to the present systems and methods, the remote entity 115 may be configured to manage the account of the individual based upon certain usage events associated with the electronic device 110. It should be appreciated that a usage event may be in the form of any type of interaction or data transmission that incorporates the electronic device 110. For example, a usage event may be the individual accessing an application installed on the electronic device 110. For further example, a usage event may be the electronic device 110 receiving a text message.

The electronic device 110 may monitor for usage events during operation of the vehicle. The usage event may correspond to any interactions by the individual with the electronic device 210, a data communication event of the electronic device 210, and/or other events or interactions. The electronic device 110 may also record whether the electronic device 110 is in communication with a peripheral component. For example, the electronic device 110 may detect a telephone call initiated by the electronic device 110 and facilitated through the use of a Bluetooth® headset. The electronic device 110 may also determine, based upon certain sensor data (e.g., seat sensor data) or registration data (e.g., whether the electronic device 110 is specified as the primary device of the vehicle 105) whether the usage event may be attributed to a vehicle operator or to a passenger.

The electronic device 110 may also retrieve certain vehicle operation data from the electronic device 107 and/or the set of sensors to determine an operation status or state of the vehicle 105. In particular, the electronic device 110 may analyze location data, speed data, ignition data, and/or other relevant data to determine whether the vehicle is in motion, stopped, on/off, or in other operational states. In some implementations, the electronic device 110 may determine its location and/or speed via interfacing with a satellite 108, such as a Global Positioning System (GPS) satellite. The electronic device 110 may also determine an operation state of the vehicle 105 through a combination of the data from the satellite 108 and data from the electronic device 107 and/or the set of sensors.

The electronic device 110 may also determine how any detected usage event(s) and the operation state or circumstance of the vehicle 105 impacts the account of the individual. In implementations, different usage events (and the circumstances of the usage events) may have different effects or impacts to the account. For example, sending a text message while the vehicle 105 is in motion may be deemed a higher risk behavior than unlocking a user interface of the electronic device 110 while the vehicle 105 is stopped. Of course, a lack of detected usage events (or even certain usage events) may have a positive effect on the account. For example, an individual declining an incoming call may be deemed to be a good behavior.

According to some embodiments, certain usage events or combinations of usage events may have corresponding effects to the account. The electronic device 110 may automatically identify the corresponding effects via a data lookup table. The electronic device 110 may account for certain time periods or defined trips over which usage events may be detected. For example, the electronic device 110, in identifying/determine effects, may consider how many usage events as well as type of usage events that are detected in a time period (e.g., day, week, month, etc.) or in a defined vehicle trip. It should be appreciated that in determining an effect, the electronic device 110 may account for a type of usage event, an amount of detected usage events, various combinations of usage events, time periods or defined trip periods/lengths, and/or other factors.

After determining an effect(s) to an account, the electronic device 110 may communicate the determined effect(s) to the insurance provider 115. Further, the electronic device 110 may present an indication(s) of the determined effect(s) to a user, such as the vehicle operator. In particular, the electronic device 110 may indicate the determined effects(s) via a user interface such that the user is able to easily and effectively gauge which events are considered good and which events are considered bad. For example, the electronic device 110 may display a red screen in response to detecting a usage event that may be deemed unsafe, and may display a green screen in response to detecting a usage event that may be deemed safe (or otherwise, not unsafe).

In some implementations, the electronic device 110 may communicate indications of any detected usage events (as well as any associated time periods, trip data, etc.) to the remote entity 115 via the network 120, whereby the remote entity 115 (or more particularly, the processing server 130) may identify the corresponding effect according to the techniques as discussed herein. The processing server 130 may interface with a database 125 to retrieve information on any determined account effects. The insurance provider 115 may also communicate directly with the electronic device 107 and/or the set of sensors 108 to retrieve vehicle operation data, and may use the vehicle operation data to determine or identify the corresponding effect.

After identifying the effect to the account, the processing server 130 may process the effect accordingly. For example, if the determined effect is an insurance premium credit, then the processing server 130 may apply the credit to a vehicle insurance policy of the policyholder. For further example, if the determined effect is a surcharge, then the processing server 130 may update the vehicle insurance policy of the policyholder to reflect the surcharge. Additionally, for example, the processing server 130 may apply, to the account, a certain amount of credits, incentives, or rewards commensurate with the effect. In processing the account, the processing server 130 may interface with the database 125 to retrieve any relevant data (e.g., insurance policy data), and make any modifications or updates.

After processing the account, the processing server 130 may communicate any associated update to the electronic device 110 via the network 120. The electronic device 110 may, in some implementations, present the associated update to the individual, such as via a user interface. In this regard, the individual is able to easily and effectively gauge how certain usage events impact his or her account. The individual may use the electronic device 110 to make certain selections, view various interfaces, or initiate certain data requests with the processing server 130. For example, the processing server 130 may offer multiple discounts or rewards to the individual, and the individual may use the electronic device 110 to select one of the discounts.

In some implementations, the processing server 130 and/or the electronic device 110 may facilitate certain functionalities that may encourage the individual to continue good behaviors and/or refrain from bad behaviors. In one scenario, the electronic device 110 may present a “challenge” to the user to refrain from certain behaviors or events for a set period of time. For example, the electronic device 110 may challenge the individual to refrain from making calls for 3,000 consecutive minutes, whereby any interruption of the phone call-free minutes may reset the counter to zero. In another scenario, the electronic device 110 may present usage data associated with other individuals, so that the individual associated with the vehicle 105 may “compete” against the other individuals in certain challenges and/or metrics. For example, the electronic device 110 may manage a game whereby individuals are rewarded points for certain encouraged usage events (and/or for refraining from certain discouraged usage events), whereby the individual with the most points at the end of a time period (e.g., a given month) is rewarded with a policy premium reduction. In this regard, the individuals may be able to ascertain how they are doing against other individuals, as well as ascertain how much they could save based upon how much other individuals are saving. It should be appreciated that other types of games, competitions, and the like are envisioned.

### III. EXEMPLARY COMMUNICATION FLOW FOR DETECTING ELECTRONIC DEVICE USAGE EVENTS AND FACILICATING ACCOUNT PROCESSING

Referring to FIG. 2, illustrated is an exemplary signal diagram 200 associated with managing user accounts and applications related thereto based upon the detection of device usage events. FIG. 2 includes one or more sensors 240, an electronic device 210 (such as the electronic device 110 as discussed with respect to FIG. 1), and a remote entity 215. The remote entity 215 may include one or more processing servers (such as the processing server 130) that facilitate various ones of the functionalities.

An individual or user associated with the electronic device 210 may have an account associated with operation of a vehicle (e.g., the individual may be a customer or policyholder having a vehicle insurance policy issued by an insurance provider 215). The individual may access the electronic device 210 to make various selections, initiate communications, and/or the like. The individual, along with the electronic device 210, may be in a vehicle, where the individual may be the vehicle operator or a passenger. At different points of time, the vehicle may be on or off, stationary or moving.

The electronic device 210 may be a mobile device such as a smartphone or other device, and/or may be a telematics device (e.g., an OEM on-board device) associated with the vehicle. In one embodiment, the electronic device 210 may interface with an existing telematics platform of the vehicle and/or with a set of sensors of the vehicle. The sensor(s) 240 may represent one or more components configured to record various operating data associated with the vehicle, such as location data, movement/velocity data, status of connections of the electronic device 210 or other components of the vehicle, audio or imaging data, and/or other data that may be detected by the sensors 240. In one implementation, one of the sensor 240 may be a GPS satellite (such as the GPS satellite 108 as discussed with respect to FIG. 1). In another implementation, the sensor(s) 240 may be a built-in component or sensor of the vehicle.

The signal diagram 200 may begin when the electronic device 210 detects (242) a usage event. According to embodiments, the usage event may correspond to the individual's interaction with the electronic device 210, a data communication event of the electronic device 210, and/or other events or interactions, as discussed herein. For example, a usage event may be a locking or an unlocking of the electronic device 210, an incoming phone call or message, an outgoing phone call or message, a typed/inputted message, a text message, a viewed message, an access of or interaction with an application such as a web browser, a utility application, a game, or the like, a connection to a peripheral device or component (e.g., a Bluetooth® headset), and/or other events. In implementations, a processor of electronic device 210 may detect the usage event(s).

The usage event may include various parameters and information such as a time, frequency, duration, type, and/or other data. For example, a usage event related to sending a text message may include a time the text message was sent and the time it took the individual to input the text message. The electronic device 210 may also detect the usage event via interfacing with another peripheral device, such as a Bluetooth® device or the like. Further, the electronic device 210 may record and maintain associated operating statuses. For example, the electronic device 210 may detect when it is connected to an active hands-free device, to a vehicle telematics platform, or the like.

In response to the electronic device 210 detecting the usage event, the electronic device 210 may retrieve/detect (244) relevant sensor data via interfacing with the sensor(s) 240. In one particular implementation, the electronic device 210 may retrieve its GPS coordinates from the sensor(s) 240. The electronic device 210 may determine/detect movement or velocity by determining multiple locations within a certain time period (e.g., by retrieving GPS locations at two different points in time). In another implementation, the electronic device 210 may interface with an on-board telematics platform of the vehicle, or another peripheral device, to retrieve any relevant location and/or movement data. In a further implementation, the electronic device 210 may retrieve audio data from a microphone that may indicate that the vehicle is operating or in motion (e.g., the microphone may detect engine noise). Additionally, in another implementation, the electronic device 210 may detect a connection to another electrical component, such as to the vehicle via a Bluetooth® connection. It should be appreciated that the electronic device 210 may communicate with other entities to determine relevant data, such as any data related to location and/or movement. For example, the electronic device 210 may determine that it is being transported in a vehicle if the electronic device 210 connects to multiple cell towers within a given period of time.

After detecting the usage event and retrieving the sensor data, the electronic device 210 may determine (248) whether it is being transported. It should be appreciated that various techniques, calculations, and thresholds to determine transport are envisioned. For example, if the electronic device 210 is traveling above a threshold speed, then the electronic device 210 may deem that it is being transported. For further example, if the electronic device 210 connects to multiple cell towers within a threshold period of time, then the electronic device 210 may deem that it is being transported. Further, for example, the electronic device 210 may deem that is being transported based upon data received from an on-board telematics platform or system of the vehicle. As an additional example, the individual may indicate, via a selection, that the electronic device 210 is being transported. It should be appreciated that if the electronic device 210 is not being transported, then the vehicle may be stationary but still on, or may be off.

If the electronic device 210 is not being transported (“NO”), processing may return to 242 in which additional usage events may be detected. If the electronic device is being transported (“YES”), then the electronic device 210 may determine (250) an effect on the account of the individual based upon the usage event. According to some embodiments, the usage events may have associated levels, degrees, or the like. For example, a phone call conducted using the electronic device 210 itself may be considered a riskier behavior than a phone call conducted with the help of a hands-free device connected to the electronic device 210. For further example, interfacing with a messaging application may be considered a riskier behavior than interfacing with a mapping application.

Each usage event may further include an associated effect or impact. In one implementation, any usage event that may be deemed to have a negative impact on physical and/or cognitive abilities may disqualify an individual from a discount or other type of reward. In some implementations, a discount or reward may be the sole incentive such that any detected usage events may not penalize the individual, per se, but may otherwise prevent the individual from qualifying for discounts or rewards. In other implementations, a given usage event that may be deemed to have a negative impact on physical and/or cognitive abilities may result in a surcharge to an account (e.g., a surcharge to a premium payment of an insurance policy). In a further implementation, some usage events may be considered negative/discouraged behaviors while other usage events may be considered positive/encouraged behaviors. For example, an unlocking of the electronic device 210 may be considered a negative behavior while a deactivation of cellular functionalities may be considered a positive behavior.

There may be a temporal or quantitative aspect associated with determining an effect or impact on an account. In some cases, the individual may qualify for a discount if the amount of usage events in a certain trip or within a certain time period is below a threshold amount (or equates to zero), and/or when positive usage events are detected during the trip or within the time period. Combinations of usage events may be considered, as well. For example, an individual sending a text message while on a voice call may be deemed riskier than an individual initiating and completing a voice call, and then sending a text message. In determining the effect or impact on the account, the electronic device 210 may consider the usage events in the collective rather than individual usage events. It should be appreciated that the electronic device 210 may incorporate various techniques, weightings, and/or calculations in determining the effect on the account. For example, the electronic device 210 may examine a lookup table based upon the detected usage event(s) or combination(s) of usage event(s) to identify a corresponding effect.

In some embodiments, the electronic device 210 may be configured to attribute various ones of the usage events to a passenger of the vehicle rather than the vehicle operator. In particular, the electronic device 210 may detect that another individual is present in the vehicle via seat sensor data, Bluetooth® connection data, the presence of multiple hands-free devices, and/or other information. In some implementations, a particular individual may be designated as the primary vehicle operator of a given vehicle, whereby a specific electronic device of the particular individual may be designated as the primary electronic device of the vehicle. Accordingly, if the usage event is attributed to the primary electronic device, then the usage event may be attributed to the vehicle operator.

Generally, if a usage event is attributed to the vehicle operator, then that usage event may have a greater effect/impact to the account; similarly, if a usage event is attributed to a passenger, then that usage event may have a lesser (or no) effect/impact to the account. For example, if a passenger is participating in a voice call, then that usage event may be deemed not as risky as if a vehicle operator is participating in a voice call; however there still may be some risk involved when the passenger is participating in the voice call.

The electronic device 210 may communicate (252) or indicate the effect to the user. In some implementations, the electronic device 210 may indicate, on a user interface, a detected usage event, as well as the effect to the account. The indication may be in the form of an active metering component, where an application of the electronic device 210 may monitor usage events and associated effects, and may indicate the usage events and associated effects as they occur and are determined.

In this regard, the user may be afforded active feedback about the usage events and associated effects. For example, when a negative usage event is detected, the electronic device 210 may flash a red shape; and when a positive usage event is detected, the electronic device 210 may flash a green shape. For further example, if a user completes a trip while avoiding usage of the electronic device 210, then the user may qualify for a $2.00 premium deduction (which may be a one-time discount or a permanent discount). The electronic device 210 may provide the feedback (and determine any corresponding effect) on a real-time basis, a per-trip basis, or a periodic basis (e.g., once/day, once/week, once/month, etc.). Therefore, in certain implementations, the effect to the account may be cumulative based upon the detection of multiple usage events (and/or on the absence of certain usage events).

The electronic device 210 may communicate or indicate the effect to the user according to various conventions, arrangements, techniques, or the like. In one exemplary implementation, the electronic device 210 may present a red/green distinction indicating whether one or more usage events negatively or positively affected a premium for a given usage event or time period. The electronic device 210 may also indicate how a given usage event differs from a “normal” or default driver. For example, if a user uses the electronic device 210 to send a message while the vehicle is traveling on a highway, then the electronic device 210 may indicate that a certain percentage (e.g., 95%) of drivers refrain from sending messages in similar circumstances. In this regard, the user may be able to ascertain how his/her behavior differs from and compares to others. It should be appreciated that other display or communication conventions, arrangements, or techniques are envisioned.

The electronic device 210 may also support a game, challenge, or competition aspect to the systems and methods, such as via a dedicated application installed on the electronic device 210. In some implementations, a challenge or goal may be initiated, whereby the usage event or combination of usage events may determine whether the challenge or goal is reached or attained. For example, the insurance provider 215 may offer (and the electronic device 210 may indicate that) a $30 premium payment discount may be attained if the user refrains from making phone calls for 3,000 consecutive minutes while the individual is traveling with the electronic device 210 in the vehicle. Additionally, the consecutive minute counter may reset if the electronic device 210 determines that a phone call has been made.

Before, during, and/or after communicating or indicating the effect to the user, the electronic device 210 may also communicate (254) the effect to the remote server 215. In some implementations, the electronic device 210 may communicate the usage event to the remote server 215 after detecting the usage, and the remote server 215 may determine the effect to the account based upon the usage event and/or combinations of multiple usage events. In particular, instead of, or in addition to, the electronic device 210 performing the calculation of either or both of (248) and (250), the remote server 215 may perform the calculation of either or both of (248) and (250). In either implementation, the remote server 215 may process or modify (256) the insurance policy based upon the effect. For example, if the effect is a $2.00 premium discount, than the remote server 215 may apply a credit of $2.00 to the insurance policy of the individual. For further example, if the effect is a $0.50 surcharge for sending a text message, then the remote server 215 may reflect the surcharge in the account of the individual.

In some implementations, such as if the remote server 215 is associated with an insurance provider, the remote server 215 may use the detected usage events to underwrite a new vehicle insurance policy or a renewal insurance policy for the individual. In this scenario, the remote server 215 may provide relevant information to the individual and facilitate a purchase transaction for the new or renewal vehicle insurance policy with the individual.

The remote server 215 may communicate (258) the change to the account to the electronic device 210. In some implementations, the remote server 215 may update an account of the user/policyholder to reflect the change, whereby the user/policyholder may use the electronic device 210 to retrieve the updated account information. When the electronic device 210 has access to the account change, the electronic device 210 may communicate or indicate (260) the account change to the user. It should be appreciated that the electronic device 210 may communicate or indicate the account change according to various conventions or techniques, as similarly discussed with respect to 252. For example, if an insurance provider discounts a premium payment by $2.00, then an application of the electronic device 210 may indicate the $2.00 premium discount to the user.

### IV. EXEMPLARY USER INTERFACES FOR MODIFYING USER ACCOUNTS

FIGS. 3A and 3B illustrate exemplary interfaces associated with presenting insurance policy modifications based upon detected usage events. An electronic device (e.g., a mobile device, such as a smartphone) may be configured to display the interfaces and/or receive selections and inputs via the interfaces. For example, a dedicated application associated with an insurance provider (or with a controller) and that is configured to operate on the electronic device may display the interfaces. It should be appreciated that the interfaces are merely exemplary and that alternative or additional content is envisioned.

FIG. 3A illustrates an interface 350 including a summary of usage events by an electronic device within a vehicle for a particular time period, as well as an effect of the usage events. The insurance provider may be configured to analyze the usage events and determine one or more effects of the usage events, as well as generate the summary of usage events based upon usage events and the one or more effects. In some implementations, the electronic device itself may perform the analysis and determination, and/or provide the results to the insurance provider.

As illustrated in FIG. 3A, the interface 350 may include a “January Activity Summary” that summarizes detected usage events by the electronic device (and the user thereof) in January. The interface 350 may detail that the mobile device usage (i.e., the detected usage events) was down 50% from December. The interface 350 may further indicate that as a result of the reduced usage events, the individual qualifies for a $5.00 premium discount. The interface 350 may enable the individual to dismiss the interface 350 via an “OKAY” selection 351. Although not illustrated in FIG. 3A, it should be appreciated that the usage events of an individual may be compared to a baseline number(s) corresponding to national averages for usage while driving. In this regard, the electronic device may determine or calculate a comparative safety score or similar metric (e.g., “By not being on your phone while driving for the past three months, you are three times less likely to get in an accident this year compared to average drivers”).

FIG. 3B illustrates an additional interface 355 that may be displayable on the electronic device, and that may indicate an additional circumstance associated with usage events of an electronic device. Similar to the interface 350 detailed in FIG. 3A, the insurance provider may be configured to analyze the usage events and determine one or more effects of the usage events, as well as generate associated details based upon usage events and the one or more effects. In some implementations, the electronic device itself may perform the analysis and determination, and provide the results to the insurance provider. It should be appreciated that the same electronic device or different electronic devices may display the respective interfaces 350, 355 of FIGS. 3A and 3B.

The interface 355 may detail usage events associated with a single trip for the vehicle. In particular, the interface 355 may indicate that the electronic device detected the communication of multiple text messages on the individual's last trip. Further, the interface 355 may indicate that sending text messages is an unsafe behavior that may result in a premium increase. In some scenarios, the insurance provider may determine to actually increase the individual's premium payment as a result of the electronic device usage. The interface 355 additionally may offer advice to eliminate driving and texting and may include an “OKAY” selection 356 that enables the individual to dismiss the interface 355.

### V. EXEMPLARY USER INTERFACES FOR REVIEWING DEVICE USAGE EVENTS

FIGS. 4A and 4B illustrate exemplary interfaces associated with presenting certain metrics and information associated with certain detected usage events. An electronic device (e.g., a mobile device, such as a smartphone) may be configured to display the interfaces and/or receive selections and inputs via the interfaces. For example, a dedicated application associated with an insurance provider (or with a controller) and that is configured to operate on the electronic device may display the interfaces. It should be appreciated that the interfaces are merely exemplary and that alternative or additional content is envisioned.

FIG. 4A illustrates an interface 450 including statistics associated with usage of the electronic device. In some implementations, the systems and methods may offer various “gaming” aspects in which individuals are encouraged to start or continue safe driving behaviors, either by decreasing and/or eliminating unsafe driving behaviors. The systems and methods may offer target goals for certain behaviors and may enable individuals to complete against one another, in some cases for real or virtual rewards. In particular, the insurance provider may retrieve usage event data from a plurality of electronic devices associated with a plurality of individuals. The insurance provider may compile and analyze the retrieved usage event data and manage various “challenges” in which the individuals may compete against each other.

As illustrated in FIG. 4A, the interface 450 may indicate that the individual has reached 2,500 consecutive minutes without interacting with the electronic device (i.e., device-free driving). The interface 450 may further encourage the user to maintain the behavior (“KEEP UP THE GOOD WORK!”). The interface 450 may enable the individual to dismiss the interface 450 via an “OKAY” selection 451 and may further enable the individual to review certain statistics via a “STATS” selection 452. In response to the user selecting the “STATS” selection 452, the electronic device may display an interface 455 as illustrated in FIG. 4B. In an additional implementation that is not illustrated in FIG. 4A, the interface 450 may indicate a certain feature or color (e.g. a flat green screen) when a user's usage (or lack thereof) is, taken as a whole, positively affecting his or her account, and another feature or color (e.g., a flat red screen) when the user's usage is negatively affecting his or her account.

The interface 455 as illustrated in FIG. 4B may include various statistics associated with an exemplary “gaming” aspect of the systems and methods. In particular, the interface 455 may include a leaderboard that details individuals who have achieved the longest current consecutive minutes streak without using their respective electronic devices while driving. The interface 455 may further include a history of certain metrics, including a longest consecutive minutes streak for the individual and an average consecutive minutes streak. As a result, the individual associated with the electronic device may be motivated to start a new consecutive minutes streak or maintain a current consecutive minutes streak. The insurance provider (or other entity managing the functionality) may offer various rewards, credits, or other incentives for achieving certain goals, being on the leaderboard, or achieving other accomplishments.

### VI. EXEMPLARY COMMUNICATION FLOW FOR MANAGING USER ACCOUNTS BASED UPON ELECTRONIC DEVICE USAGE EVENTS

Referring to FIG. 5, depicted is a block diagram of an exemplary method 500 of managing user accounts based upon usage events associated with an electronic or mobile device. The electronic or mobile device may be in direct or indirect communication a remote server. The method 500 may be facilitated by the electronic device communicating with the remote entity 115 (and specifically the processing server 130) as well as a user of the electronic device. The user (who may be the holder of the account, such as a vehicle insurance policy) may access the electronic device to view information and make appropriate selections.

The method 500 may begin when the electronic device detects (block 505) a usage event associated with the electronic device. As discussed herein, the usage event may be an access of an application, a communication initiated by the electronic device, a communication destined for the electronic device, an unlocking event of the electronic device, any connection to a peripheral device or component by the electronic device, and/or other events or interactions. In some scenarios, the electronic device may detect multiple usage events. In response to detecting the usage event, the electronic device may detect (block 510) sensor data. In particular, the electronic device may identify its GPS coordinates, or may estimate/determine its location via other techniques (e.g., cellular triangulation). In some implementations, the electronic device may estimate/determine its velocity, such as by identifying multiple locations at different times or by interfacing with an on-board telematics platform of the vehicle, may detect any connections to peripheral components or devices, or may detect other sensor data. It should be appreciated that the electronic device may detect sensor data associated with one or more sensors that are built into the electronic device.

Based upon the sensor data, the electronic device may determine (block 515) whether it is being transported. In particular, if the sensor data indicates characteristics associated with travel, then the electronic device may deem that it is being transported within a vehicle. For example, the electronic device may deem that is it being transported if an estimated/determined velocity is above a threshold amount, if the electronic device connects to multiple cellular towers with a certain time period, or if received telematics data indicates vehicle movement. If the electronic device determines that it is not being transported (“NO”), processing may return to the beginning or proceed to other functionality.

If the electronic device determines that it is being transported (“YES”), the electronic device may determine (block 520), based upon the usage event, an effect to the account of the user. In some implementations, the electronic device may examine a lookup table to identify the effect to the account of the user that corresponds to the detected usage event. As discussed herein, different usage events may have different account effects. Further, a certain usage event may have a positive effect on an account (i.e., the usage event may be an encouraged behavior) while another usage event may have a negative effect on an account (i.e., the usage event may be a discouraged behavior). The electronic device may also consider various combinations of usage events. In some implementations, the electronic device may determine, based upon various sensor data or user selections, whether the usage event is attributed to a driver of the vehicle or a passenger of the vehicle.

The electronic device may optionally present (block 525) the effect to the account to the user of the electronic device. In particular, the electronic device may indicate, in a user interface, the detected usage event as well as the determined effect. For example, if the user sends a text message (i.e., the usage event) that results in a text limit threshold being exceeded, then the electronic device may indicate the sending of the text message along with the threshold being exceeded. The electronic device may also communicate (block 530), to the remote server, the effect to the account of the user. The remote server may process the account accordingly. For example, if an amount of detected usage events does not exceed a threshold amount, then the remote server may apply a credit to the account of the user. In some implementations, the electronic device may communicate an indication of the usage event to the remote server, and the remote server may determine the effect associated with the usage event.

The electronic device may receive (block 535), from the remote server, a confirmation that the effect has been applied to the account of the user. For example, the effect may be a premium payment adjustment, a discount on a future insurance product, a monetary or virtual reward, or other type of effect. The electronic device may also present (block 540), in a user interface of the electronic device, the confirmation that the effect has been applied to the account of the user. In this regard, the user is able to effectively gauge changes to the account, view earned monetary or virtual rewards, keep track of certain statuses related to the account or to various “games” associated with the systems and methods, and/or assess other information.

### VII. EXEMPLARY ADDITIONAL COMMUNICATION FLOW FOR MANAGING USER ACCOUNTS BASED UPON ELECTRONIC DEVICE USAGE EVENTS

Referring to FIG. 6, depicted is a block diagram of an additional exemplary method 600 of managing user accounts based upon usage events associated with an electronic device. The electronic device may be in direct or indirect communication a remote server. The method 600 may be facilitated by the electronic device communicating with the remote entity 115 (and specifically the processing server 130) as well as a user of the electronic device. The user may be an individual having an account with the remote entity, and who may access the electronic device to view information and make appropriate selections.

The method 600 may begin when the electronic device detects (block 605) an initiation of a trip by a vehicle. The trip may initiate when the engine of the vehicle initiates or is turned on, when the vehicle starts moving, or in response to other triggers or conditions. Further, the electronic may detect the trip initiation via one or more various sensors, an input or selection by an individual, or via other techniques or components. The electronic device may monitor (block 610) usage of the electronic device by the individual during the trip. As discussed herein, the electronic device may monitor the usage via various user interactions, received/sent communications, peripheral device connections, and/or other events.

The electronic device may also monitor (block 615) for conclusion of the trip. The trip may conclude when the engine of the vehicle shuts off, when the vehicle stops moving, when the vehicle remains stopped for a threshold period of time, when the individual has indicated that the trip has concluded, or in response to other triggers or conditions. Further, the electronic device may detect the trip conclusion via one or more various sensors, via an input by an individual, or via other techniques or components. If the trip is not concluded (“NO”), processing may return to 610 for further usage monitoring. If the trip is concluded (“YES”), the electronic device may analyze (block 620) the usage of the electronic device by the individual during the trip. The usage may indicate various user interactions, received/sent communications, peripheral device connections, and/or other events or occurrences that may have occurred during the trip.

The electronic device may determine (block 625) whether there was any interaction with the electronic device by the individual during the trip. In some implementations, the electronic device may determine a number of interaction instances, as well as corresponding degrees of device interaction. For example, the individual may place a phone call that lasts longer than ten (10) minutes. For further example, sending a text message may be considered a riskier/more negative interaction than unlocking the electronic device. In some implementations, the electronic device may determine, based upon various sensor data or user selections, whether the interaction(s) is attributed to a driver of the vehicle or a passenger of the vehicle. It should be appreciated that, in general, some of interaction events may be deemed negative and other interaction events may be deemed positive.

If the electronic device determines that there is an interaction(s) by the individual (“YES”), processing may end. In some implementations, processing may proceed to other functionality whereby the electronic device or the remote server may determine an appropriate effect to the vehicle insurance policy, based upon the interaction(s). For example, a premium amount of an insurance policy may be increased a certain amount depending upon the amount and type of interaction(s).

If the electronic device determines that there are no interactions by the individual with the electronic device (or if a number of interactions(s) is below a threshold level) (“NO”), the electronic device may determine (block 630) an effect to the account of the individual. In some embodiments, because no interactions (or interaction(s) below a threshold level) may be considered a safe driving behavior, then the effect may be positive for the individual (or may generally be an incentive for the individual). The electronic device may optionally present (block 635), to the individual, the effect to the account of the individual.

In particular, the electronic device may indicate the determined effect in a user interface. For example, if the individual refrains from interacting with the electronic device for 100 consecutive miles, which results in a $2.00 premium discount, the electronic device may indicate that the individual qualifies for the $2.00 premium discount. The electronic device may also communicate (block 640), to the remote server, the effect to the account of the individual. The remote server may process the account of the individual accordingly. In some implementations, the electronic device may communicate data related to any interaction(s) (or lack thereof) by the individual, and the remote server may determine the effect accordingly.

The electronic device may receive (block 645), from the remote server, a confirmation that the effect has been applied to the account of the individual. For example, the effect may be a premium payment adjustment, a discount on a future insurance product, a monetary or virtual reward, or other type of effect. The electronic device may also present (block 650), in a user interface of the electronic device, the confirmation that the effect has been applied to the account of the individual. In this regard, the individual is able to effectively gauge changes to the account, view earned monetary or virtual rewards, keep track of certain statuses related to the policy or to various “games” associated with the systems and methods, and/or assess other information. The method may include additional, fewer, or alternate actions, including those discussed elsewhere herein.

### VIII. EXEMPLARY MOBILE OR OTHER ELECTRONIC DEVICE

FIG. 7 illustrates a diagram of an exemplary mobile or other electronic device 710 (such as the electronic device 110 discussed with respect to FIG. 1) in which the functionalities as discussed herein may be implemented. It should be appreciated that the electronic device 710 may be configured to be transported in a vehicle and/or connect to an on-board telematics platform of the vehicle, as discussed herein.

The controller 720 may include a processor 722 as well as a memory 778. The memory 778 may store an operating system 779 capable of facilitating the functionalities as discussed herein as well as a set of applications 775 (i.e., machine readable instructions). For example, one of the set of applications 775 may be an event detection application 790 configured to detect usage events associated with the electronic device 720, and an interaction challenge application 791 configured to manage any “gaming” or “challenge” aspects of the systems and methods. It should be appreciated that one or more other applications 792 are envisioned, such as an application associated with an insurance provider.

The processor 722 may interface with the memory 778 to execute the operating system 779 and the set of applications 775. According to some embodiments, the memory 778 may also include an effects record 780 that stores certain account effects that may be associated with any detected usage events. In some implementations, the event detection application 790 may interface with the effects record 780 to determine any effects to a a user account based upon the determined usage events. Another of the set of applications 775 may also interface with the effects record 780 to accordingly process any user accounts. The memory 778 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 710 may further include a communication module 777 configured to communicate data via one or more networks 720. According to some embodiments, the communication module 777 may include one or more transceivers (e.g., WWAN, WLAN, and/or WPAN transceivers) functioning in accordance with IEEE standards, 3GPP standards, or other standards, and configured to receive and transmit data via one or more external ports 776. Further, the communication module 777 may include a short-range network component (e.g., an RFID reader) configured for short-range network communications. For example, the communication module 777 may receive, via the network 720, telematics data from an on-board telematics platform of a vehicle. For further example, the communication module 777 may transmit data to and receive data from a remote insurance provider via the network 720.

The electronic device 710 may further include a user interface 781 configured to present information to a user and/or receive inputs from the user. As shown in FIG. 7, the user interface 781 may include a display screen 782 and I/O components 783 (e.g., ports, capacitive or resistive touch sensitive input panels, keys, buttons, lights, LEDs, speakers, microphones). According to some embodiments, the user may access the electronic device 710 via the user interface 781 to process insurance policies and/or perform other functions. In some embodiments, the electronic device 710 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 722 (e.g., working in connection with the operating system 779) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

### IX. EXEMPLARY SERVER

FIG. 8 illustrates a diagram of an exemplary processing server 830 (such as the processing server 130 discussed with respect to FIG. 1) in which the functionalities as discussed herein may be implemented. It should be appreciated that the processing server 830 may be associated with an insurance provider or other entities, as discussed herein.

The processing server 830 may include a processor 722, as well as a memory 878. The memory 878 may store an operating system 879 capable of facilitating the functionalities as discussed herein as well as a set of applications 875 (i.e., machine readable instructions). For example, one of the set of applications 875 may be an account processing application 884 configured to manage user accounts. In particular, the account processing application 884 may process usage event data received from an electronic device associated with a vehicle, and determine any effects to an associated user account. It should be appreciated that other applications 890 are envisioned.

The processor 822 may interface with the memory 878 to execute the operating system 879 and the set of applications 875. According to some embodiments, the memory 878 may also include a data record storage 880 that stores various information associated with customer insurance policies. The policy processing application 884 may interface with the data record storage 880 to retrieve relevant information that the account processing application 884 may use to manage user accounts, determine effects to user accounts, generate notifications, and/or perform other functionalities. The memory 878 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The processing server 830 may further include a communication module 877 configured to communicate data via one or more networks 820. According to some embodiments, the communication module 877 may include one or more transceivers (e.g., WWAN, WLAN, and/or WPAN transceivers) functioning in accordance with IEEE standards, 3GPP standards, or other standards, and configured to receive and transmit data via one or more external ports 876. For example, the communication module 877 may receive, via the network 820, usage events detected by an electronic device traveling in a vehicle.

The processing server 830 may further include a user interface 881 configured to present information to a user and/or receive inputs from the user. As shown in FIG. 8, the user interface 881 may include a display screen 882 and I/O components 883 (e.g., ports, capacitive or resistive touch sensitive input panels, keys, buttons, lights, LEDs, speakers, microphones). According to some embodiments, the user may access the processing server 830 via the user interface 881 to process insurance policies and/or perform other functions. In some embodiments, the processing server 830 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 822 (e.g., working in connection with the operating system 879) to facilitate the functions as described herein. In this regard, the program code may be implemented in any desired language, and/or may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

### X. EXEMPLARY METHOD OF MANAGING USER ACCOUNTS

In one aspect, a method in an electronic device of managing an account of a user associated with a vehicle based upon usage associated with the electronic device may be provided. The method may include: (1) detecting at least one usage event associated with the electronic device; (2) detecting sensor data in response to detecting the at least one usage event; (3) determining, by one or more processors based upon the sensor data, that the electronic device is being transported by the vehicle; (4) determining, by the one or more processors based upon the at least one usage event, an effect to the account of the user; and (5) communicating, to a remote server via a communication module, an indication of the effect to the account of the user, wherein the remote server processes the account of the user according to the effect. The method may include additional, fewer, or alternate actions, including those discussed elsewhere herein.

For instance, in one implementation, the method may detect the sensor data by (1) at a first time, identifying a first location of the electronic device; and (2) at a second time, identifying a second location of the electronic device. In another implementation, the method may detect the usage event by detecting at least one of: a selection of an input, an access of an application, a communication initiated by the electronic device, a communication destined for the electronic device, and a connection to a peripheral device.

In a further implementation, the electronic device may be connected to a peripheral device via a short range communication. Further, the method may detect the at least one usage event by detecting at least one usage event at least partly facilitated by the peripheral device. The method may also determine the effect to the account of the user by examining a lookup table to identify the effect to the account of the user corresponding to the at least one usage event.

In a further implementation, the at least one usage event may include a first usage event and a second usage event. Further, the method may determine the effect to the account of the user by determining a cumulative effect to the account of the user based upon the first usage event and the second usage event.

In another implementation, the method may determine the effect to the account of the user by determining a modification to a premium amount associated with a vehicle insurance policy. Further, the method may determine the effect to the account of the user by determining an incentive or reward to apply to the account of the user. The method may additionally or alternatively include (1) receiving, from the remote server via the communication module, a confirmation that the effect has been applied to the account of the user; and (2) presenting, in a user interface of the electronic device, the confirmation that the effect has been applied to the account of the user.

In a further implementation, the method may determine, based upon the sensor data, that the electronic device is being transported by the vehicle determining, based upon the sensor data, that the electronic device is being transported by the vehicle in a particular circumstance. Additionally, the method may determine, based upon the sensor data, that the electronic device is being transported by the vehicle by determining, based upon the sensor data, that the at least one usage event is associated with an operator of the vehicle.

### XI. EXEMPLARY METHOD OF REWARDING AN INDIVIDUAL

In another aspect, a method in an electronic device of rewarding, based upon usage associated with the electronic device, an individual having an account associated with a vehicle, may be provided. The method may include: (1) detecting an initiation of a trip by the vehicle; (2) monitoring, by one or more processors, usage of the electronic device by the individual during the trip; (3) detecting a conclusion of the trip; and (4) responsive to detecting the conclusion of the trip: (i) analyzing, by the one or more processors, the usage of the electronic device by the individual during the trip, (ii) based upon the analyzing, determining that the individual did not interact with the electronic device during the trip, (iii) determining, by the one or more processors, an effect to the account of the individual, and (iv) communicating, to a remote server via a communication module, an indication of the effect to the account of the individual, wherein the remote server processes the account of the individual according to the effect. The method may include additional, fewer, or alternate actions, including those discussed elsewhere herein.

For example, in one implementation, the method may analyze the usage of the electronic device by the individual during the trip by analyzing at least one of: a selection of an input, an access of an application, a communication initiated by the electronic device, a communication destined for the electronic device, and a connection to a peripheral device. In another implementation, the method may determine the effect to the account of the individual by examining a lookup table to identify the effect to the account of the individual corresponding to the individual not interacting with the electronic device during the trip.

In a further implementation, the method may determine the effect to the account of the individual by determining a modification to a premium amount associated with a vehicle insurance policy. Additionally or alternatively, the method may include: (1) receiving, from the remote server via the communication module, a confirmation that the effect has been applied to the account of the individual; and (2) presenting, in a user interface of the electronic device, the confirmation that the effect has been applied to the account of the individual.

In yet a further implementation, the method may further include, in response to detecting the conclusion of the trip: (1) updating, based upon the usage of the electronic device, usage statistics associated with the account of the individual, and presenting the updated usage statistics in a user interface of the electronic device.

### XII. EXEMPLARY SYSTEM OF MANAGING VEHICLE INSURANCE POLICIES

In one aspect, a system for managing an account of a user based upon usage associated with an electronic device may be provided. The system may include: (1) a communication module configured to communicate data; (2) a memory adapted to store non-transitory computer executable instructions; and (3) a particularly programmed processor adapted to interface with the communication module. The processor may be configured to execute the non-transitory computer executable instructions to cause the processor to: (i) receive, from an electronic device via the communication module, an indication of at least one usage event associated with the electronic device and sensor data, (ii) determine, based upon the sensor data, that the electronic device is being transported by the vehicle, (iii) determine, based upon the at least one usage event, an effect to the account of the user, and (iv) process the account of the user according to the effect. The system may include additional, less, or alternate functionality, including that discussed elsewhere herein.

In one implementation, the processor may be configured to execute the computer executable instructions to further cause the processor to communicate, to the electronic device via the communication module, an indication of the effect to the account of the user. In another implementation, the processor may determine that the electronic device is being transported by the vehicle by: (i) receiving the sensor data from the electronic device via the communication module, and (ii) examining the sensor data to determine that the electronic device is being transported by the vehicle.

In another implementation, the processor may determine the effect to the account of the user by examining a lookup table to identify the effect to the account corresponding to the at least one usage event. In another implementation, the at least one usage event may include a first usage event and a second usage event, and the processor may determine the effect to the account of the user by determining a cumulative effect to the account of the user based upon the first usage event and the second usage event. In yet another implementation, the processor may determine the effect to the account of the user by determining a modification to a premium amount associated with a vehicle insurance policy.

### XIII. ADDITIONAL EXEMPLARY METHODS

In one aspect, a computer-implemented method of managing an insurance policy associated with an insured vehicle or an insured driver based upon driver mobile device usage may be provided. The method may include (1) detecting or determining, via one or more processors (such as via processors or applications of a mobile device, a smart vehicle controller, and/or a remote server), that an insured vehicle associated with an insured driver is moving (such as by using information generated or collected by a GPS unit, an accelerometer, or a speed sensor mounted on the mobile device and/or insured vehicle); (2) monitoring, via the one or more processors, a mobile device associated with the insured driver for mobile device usage while the insured vehicle is moving; (3) adjusting or updating, via the one or more processors, an insurance policy, premium, rate, and/or discount associated with the insured driver and/or insured vehicle based upon an amount and/or type of mobile device usage that is detected when the insured vehicle is moving; and/or (4) causing or directing, via the one or more processors, the adjusted or updated insurance policy, premium, rate, and/or discount to be presented on a display of the mobile device for review by the insured driver and/or an owner of the insured vehicle such that distraction-free vehicle operation is encouraged or rewarded. The method may further include determining, via the one or more processors, that the mobile device is being, or likely being, operated by the insured driver as the insured driver is driving the insured vehicle (such as via triangulation or other known techniques to associate the mobile device within an area corresponding to the driver's seat of the insured vehicle).

The type of mobile device usage may be associated with viewing texts, typing texts, web browsing, internet usage, incoming telephone calls, receiving alerts or notifications including visual and/or auditory signals (e.g., calendar events or incoming texts/emails/calls), and/or outgoing telephone calls. In certain implementations, the electronic device may be configured to interface with native settings to determine relevant settings (e.g., muting of ringer and status of notifications). The method may further include determining, via the one or more processors, that the mobile device is connected to a hands-free device during the mobile device usage detected, and adjusting the insurance policy to reflect hands-free mobile device usage. The type of mobile device usage detected may be associated with a lack of, or no, viewing texts, typing texts, web browsing, internet usage, incoming telephone calls, outgoing telephone calls, and/or other mobile device usage. The method may include additional, fewer, or alternate actions, including those discussed elsewhere herein.

In another aspect, a computer-implemented method of managing an insurance policy associated with an insured vehicle or an insured driver based upon driver mobile device usage may be provided. The method may include (1) detecting or determining, via one or more processors (such as via processors or applications of a mobile device, a smart vehicle controller, and/or a remote server), that an insured vehicle associated with an insured driver is moving (such as by using information generated or collected by a GPS unit, an accelerometer, or a speed sensor mounted on the mobile device and/or insured vehicle); (2) monitoring, via the one or more processors, for mobile device usage within the insured vehicle when the insured vehicle is determined to be moving or otherwise traveling on the road; and/or (3) if no mobile device usage within the insured vehicle is detected or determined when the insured vehicle is determined to be moving (or otherwise traveling on the road), then adjusting or updating, via the one or more processors, an insurance policy or rate associated with the insured vehicle, the insured driver, and/or an owner of the insured vehicle, such as by lowering an insurance premium or increasing an insurance discount to facilitate enticing safe and distraction-free vehicle operation.

The method may further include: if mobile device usage within the insured vehicle is detected or determined when the insured vehicle is determined to be moving (or otherwise traveling on the road), then determining or detecting, via the one or more processors, an amount and/or a type of the mobile device usage; and/or adjusting or updating, an insurance policy, rate, premium, and/or discount associated with the insured vehicle, insured driver, and/or an owner of the insured vehicle based upon the amount and/or type of mobile device usage that is detected when the insured vehicle is moving to facilitate a more accurate reflection and pricing of risk. The type of mobile device usage may be associated with viewing texts, typing texts, web browsing, internet usage, incoming telephone calls, and/or outgoing telephone calls. The method may include additional, fewer, or alternate actions, including those discussed elsewhere herein.

In another aspect, a computer-implemented method of managing an insurance policy associated with an insured vehicle or an insured driver based upon driver mobile device usage may be provided. The method may include (i) detecting or determining, via one or more processors (such as via processors or applications of a mobile device, a smart vehicle controller, and/or a remote server), a mobile device usage event associated with a mobile device of an insured driver; (ii) detecting or determining, via the one or more processors, that the mobile device is located within, or likely located within, a moving vehicle (and/or determining that the moving vehicle is associated with the mobile device or insured driver, and is moving) (such as by using a GPS unit, accelerometer, or speed sensor mounted on the mobile device (and/or moving vehicle)); (iii) determining, via the one or more processors, that the mobile device is being, or likely being, operated by the insured driver as the insured driver drives the moving vehicle (such as via triangulation or other known techniques, or by analyzing or using information about the insured driver with their permission, such as by using information that the insured does not normally use public transportation and/or that they typically travel or commute via their personal vehicle); and/or (iv) when, or based upon, (1) the mobile device usage event is detected; (2) the mobile device is located within the moving vehicle; and/or (at the same time as) (3) the mobile device is being, or likely being, operated by the insured driver as they are currently driving the moving vehicle, an insurance policy, rate, premium, and/or discount may be (subsequently, and/or in real or near real time) adjusted, via the one or more processors, for the insured driver based upon a type of the mobile device usage event (or an amount of mobile device usage) detected, and/or a lack of mobile device usage or usage events being detected.

The type of mobile device usage event may be associated with viewing texts, typing texts, web browsing, internet usage, incoming telephone calls, and/or outgoing telephone calls. The type of mobile device usage event detected may be associated with hands-free activity and/or the mobile device acting as a hands-free device. Additionally or alternatively, the type of mobile device usage event detected may be associated with a lack of, or no, viewing texts, typing texts, web browsing, incoming telephone calls, outgoing telephone calls, and/or other mobile device usage. The moving vehicle may be determined to be moving, via the one or more processors, from speed information, GPS information, and/or cell tower information, such as information indicating that a primary cell tower in wireless communication with, and servicing, the mobile device has switched within a given period of time (indicating fast movement). The method may include additional, fewer, or alternate actions, including those discussed elsewhere herein.

In another aspect, a computer-implemented method of managing an insurance policy associated with an insured vehicle based upon driver mobile device usage may be provided. The method may include: (1) determining, via one or more processors, that an insured vehicle is moving (such as from data generated or collected by a mobile device and/or vehicle GPS unit, accelerometer, speedometer, other speed sensor, other means for determining vehicle speed, and/or other sensors mounted on the mobile device or insured vehicle); (2) detecting, via the one or more processors, that the mobile device is located within a vicinity of a driver's seat of the insured vehicle (such as determining that the mobile device is within a quadrant of the vehicle associated with the driver's seat via triangulation or other techniques performed between or among the mobile device and vehicle mounted sensors and/or transceivers); (3) detecting, via the one or more processors, a mobile device usage event (and/or lack thereof) associated with the mobile device that is located within the vicinity of the driver's seat at the same time as when the insured vehicle is moving; (4) classifying, via the one or more processors, the mobile device usage event (associated with the mobile device located within the vicinity of (i) the driver's seat, or (ii) other area of insured vehicle associated with driving the insured vehicle) that occurs while the insured vehicle is moving (or otherwise being driven on the road); and/or (5) adjusting, via the one or more processors, an insurance policy (such as adjusting or generating an insurance premium, rate, discount, reward, points, etc.) associated with the insured vehicle or an owner of the insured vehicle based upon the classification of the mobile device usage event that occurred (i) while the vehicle was moving, and/or (ii) while the mobile device was within the vicinity of the driver's seat to facilitate more accurate automobile insurance pricing or risk determinations.

The method may also include causing, by the one or more processors, a communication, such as via wired or wireless communication, associated with the adjusted insurance policy to be presented to the owner or a driver of the vehicle. The method may further include determining, via the one or more processors, an identification of the driver of the insured vehicle that used the mobile device while driving the insured vehicle, such as by mobile device signal recognition techniques or by facial feature recognition techniques performed on images of the driver, such as images of the driver taken by mobile devices and/or vehicle mounted cameras; and/or adjusting, via the one or more processors, an insurance policy, premium, rate, or discount for the driver identified. The method may include additional, fewer, or alternate actions, including those discussed elsewhere herein.

The one or more processors may include local or remote processors. Local processors may include or be associated with a mobile device (such as a smart phone, tablet, phablet, laptop, PDA (personal digital assistant), smart watch, smart glasses, smart bracelet, etc.), a smart vehicle or smart vehicle controller, and/or a telematics device. Remote processors may include remote processors or servers associated with an insurance provider. The local or remote processors may be in wired or wireless communication with one another.

The one or more processors may be configured to classify each mobile device usage event, and/or an amount time of each usage event. For instance, mobile device usage events may be classified by activities associated with the mobile device, such as by frequency, duration, and/or type (e.g., incoming text, outgoing text, web-surfing, internet usages, incoming call(s), outgoing call(s), hands-free activity or usage, etc.). The mobile device usage events may additionally or alternatively be classified by vehicle usage or movement of a vehicle that the owner of the mobile device is determined to be driving. The vehicle usage may be classified as not moving, vehicle parking, vehicle speed, vehicle moving, etc.

The insurance policy adjusted may be a vehicle insurance policy associated with, or covering, a vehicle, and/or an insurance policy associated with, or covering, the driver or drivers of the vehicle. The insurance policy may also be associated with life insurance, or health insurance.

### XIV. ADDITIONAL CONSIDERATIONS

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

Although the embodiments discussed herein relate to vehicle insurance policies, it should be appreciated that an insurance provider may offer or provide one or more different types of insurance policies. Other types of insurance policies may include, for example, homeowners insurance, condominium owner insurance, renter's insurance, life insurance (e.g., whole-life, universal, variable, term), health insurance, disability insurance, long-term care insurance, annuities, business insurance (e.g., property, liability, commercial auto, workers compensation, professional and specialty liability, inland marine and mobile property, surety and fidelity bonds), automobile insurance, boat insurance, insurance for catastrophic events such as flood, fire, volcano damage and the like, motorcycle insurance, farm and ranch insurance, personal liability insurance, personal umbrella insurance, community organization insurance (e.g., for associations, religious organizations, cooperatives), and other types of insurance products. In embodiments as described herein, the insurance providers process claims related to insurance policies that cover one or more properties (e.g., homes, automobiles, personal property), although processing other insurance policies may also be envisioned.

The terms “insured,” “insured party,” “policyholder,” “customer,” “claimant,” and “potential claimant” are used interchangeably herein to refer to a person, party, or entity (e.g., a business or other organizational entity) that is covered by the insurance policy, e.g., whose insured article or entity (e.g., property, life, health, auto, home, business) is covered by the policy. A “guarantor,” as used herein, generally refers to a person, party or entity that is responsible for payment of the insurance premiums. The guarantor may or may not be the same party as the insured, such as in situations when a guarantor has power of attorney for the insured. An “annuitant,” as referred to herein, generally refers to a person, party or entity that is entitled to receive benefits from an annuity insurance product offered by the insuring party. The annuitant may or may not be the same party as the guarantor.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. A computer-implemented method in an electronic device of managing an account of an operator of a vehicle based upon usage associated with the electronic device, the method comprising:
after initiation of a trip by the vehicle:
detecting a first usage event associated with the electronic device, and
detecting a second usage event associated with the electronic device;
in response to detecting the first usage event and the second usage event, accessing registration data indicative of whether the electronic device is specified as a primary device of the vehicle;
determining, by one or more processors based upon the registration data, that the first usage event and the second usage event are attributed to the operator of the vehicle;
in response to determining that the first usage event and the second usage event are attributed to the operator of the vehicle:
detecting, from a location module, a first set of coordinates representative of a first location of the electronic device, and
within a time period of detecting the first set of coordinates, detecting, from the location module, a second set of coordinates representative of a second location of the electronic device;
determining, by one or more processors based upon the first location and the second location, that the electronic device is being transported by the vehicle;
after conclusion of the trip by the vehicle, determining, by the one or more processors based upon the first usage event and the second usage event, a cumulative effect to the account of the operator; and
communicating, to a remote server via a communication module, an indication of the cumulative effect to the account of the operator, wherein the remote server processes the account of the operator according to the effect.

2. (canceled)

3. The method of claim 1, wherein detecting the first usage event comprises:
detecting at least one of: a selection of an input, an access of an application, a communication initiated by the electronic device, a communication destined for the electronic device, and a connection to a peripheral device.

4. The method of claim 1, wherein the electronic device is connected to a peripheral device via a short range communication, and wherein detecting the first usage event comprises:
detecting the first usage event, the first usage event at least partly facilitated by the peripheral device.

5. The method of claim 1, wherein determining the cumulative effect to the account of the user comprises:
examining a lookup table to identify the cumulative effect to the account of the operator corresponding to the first usage event and the second usage event.

6. (canceled)

7. The method of claim 1, wherein the account of the operator includes a vehicle insurance policy held by the user, and wherein determining the cumulative effect to the account of the user comprises:
determining a modification to a premium amount associated with the vehicle insurance policy.

8. The method of claim 1, wherein determining the cumulative effect to the account of the operator comprises:
determining an incentive or reward to apply to the account of the operator.

9. The method of claim 1, further comprising:
receiving, from the remote server via the communication module, a confirmation that the cumulative effect has been applied to the account of the operator; and
presenting, in a user interface of the electronic device, the confirmation that the cumulative effect has been applied to the account of the operator.

10. The method of claim 1, wherein determining, based upon the first location and the second location, that the electronic device is being transported by the vehicle comprises:
determining, based upon the first location and the second location, that the electronic device is being transported by the vehicle in a particular circumstance.

11-17. (canceled)

18. A system for managing an account of an operator of a vehicle based upon usage associated with an electronic device, comprising:
a transceiver for communicating data;
a memory storing non-transitory computer executable instructions; and
a particularly programmed processor interfacing with the communication module, wherein the processor is configured to execute the non-transitory computer executable instructions to cause the processor to:
after initiation of a trip by the vehicle:
receive, from an electronic device via the transceiver, (i) a first indication of a first usage event associated with the electronic device, (ii) a second indication of a second usage event associated with the electronic device, (iii) a first set of coordinates detected by a location module of the electronic device and representative of a first location of the electronic device, and (iv) a second set of coordinates detected by the location module within a time period of the location module detecting the first set of coordinates and representative of a second location of the electronic device,
accessing registration data indicative of whether the electronic device is specified as a primary device of the vehicle;
determine, based upon the registration data, that the first usage event and the second usage event are attributed to the operator of the vehicle,
determine, based upon the first location and the second location, that the electronic device is being transported by a vehicle,
after conclusion of the trip by the vehicle, determine, based upon the first usage event and the second usage event, a cumulative effect to the account of the operator, and
process the account of the operator according to the cumulative effect.

19. The system of claim 18, wherein the processor is configured to execute the computer executable instructions to further cause the processor to:
communicate, to the electronic device via the transceiver, an indication of the cumulative effect to the account of the operator.

20. The system of claim 18, wherein to determine the cumulative effect to the account of the operator, the processor is configured to:
examine a lookup table to identify the cumulative effect to the account of the operator corresponding to the first usage event and the second usage event.

21. (canceled)

22. The system of claim 18, wherein to determine the cumulative effect to the account of the operator, the processor is configured to:
determine a modification to a premium amount associated with the vehicle insurance policy.
